(19) United States
(12) Patent Application Publication
(10) Pub. No.: US 2024/0106080 A1
(43) Pub. Date: Mar. 28, 2024

(54) THERMAL RUNAWAY-PREVENTING BUSBAR DEVICE AND BATTERY SYSTEM

(71) Applicant: HYUNDAI MOBIS CO., LTD., Seoul (KR)

(72) Inventors: Heui Chang YANG, Yongin-si (KR); Won Yong KI, Yongin-si (KR)

(73) Assignee: HYUNDAI MOBIS CO., LTD., Seoul (KR)

(21) Appl. No.: 18/373,492

(22) Filed: Sep. 27, 2023

(30) Foreign Application Priority Data
Sep. 27, 2022 (KR) 10-2022-0122629

(51) Int. Cl. H01M 50/507; H01M 10/6551; H01M 10/6557; H01M 50/209; H01M 50/211; H01M 50/383; H01M 50/526

(52) U.S. Cl. CPC H01M 50/507; H01M 10/6551; H01M 10/6557; H01M 50/209; H01M 50/211; H01M 50/383; H01M 50/526

(57) ABSTRACT

A thermal runaway-preventing busbar device according to an embodiment of the present invention includes a pair of first busbars disposed in parallel, each first busbar of the pair of first busbars including a first body extending in a longitudinal direction and first connectors, which are respectively connected to both ends of the first body, a pair of second busbars disposed on both sides in a width direction with the pair of first busbars interposed therebetween, each second busbar of the pair of second busbars including a second body extending parallel to the first body and second connectors, which are bent and extended in directions opposite to the first body at both ends of the second body, a holder insertion-coupled to the first body and the second body so that the first body is spaced a regular interval from the second body, and a frame which is mounted within a separation space provided between battery modules and includes an accommodation groove to accommodate the pair of first busbars and the pair of second busbars therein.

### CROSS-REFERENCE TO RELATED APPLICATION

This application claims priority to and the benefit of Korean Patent Application No. 10-2022-0122629, filed on Sep. 27, 2022, in the Korean Intellectual Property Office, the disclosure of which is incorporated herein by reference in its entirety.

### BACKGROUND

### 1. Field of the Invention

The present invention relates to a thermal runaway-preventing busbar device and battery system, and more particularly, to a thermal runaway-preventing busbar device and battery system capable of securing thermal runaway prevention performance.

### 2. Discussion of Related Art

Lithium-ion batteries with high energy density are mainly used in electric vehicles and energy storage system (ESS) batteries. However, compared to other batteries, lithium-ion batteries are vulnerable to fire.

In general, when the internal temperature of a lithium-ion battery is approximately 170° C. or more, thermal runaway occurs. Thermal runaway is a situation in which, when a cell surrounded by batteries explodes, a temperature exceeds a withstand temperature and ignition occurs, continuously igniting surrounding modules and components, which are exploded in a chain.

In the case of a battery system provided by arranging a plurality of battery modules in a grid form, busbars through which battery modules are electrically connected are disposed on the module and form connecting paths for the modules.

In this case, when any one battery module has a problem, heat is transferred to another battery module through a busbar formed of copper with high thermal conductivity, and the risk of fire is increased due to thermal runaway.

In order to prevent such thermal diffusion, a high heat-resistant exterior material (e.g., mica) is applied to the busbar passing over a thermal runaway trigger module. However, in the case of a high voltage battery, the thickness of an exterior material inevitably becomes thick due to high energy output.

Accordingly, it becomes difficult to secure a gap between the exterior material and an upper cover, and it becomes difficult to apply a gas valve that prevents internal and external pressure equilibrium collapse of the battery system due to the generation of toxic gas caused by combustion. In addition, a problem of increasing costs occurs. That is, there are problems of spatial inefficiency and difficulty in applying unified exterior material specifications.

Accordingly, it is necessary to address the above problems.

### SUMMARY OF THE INVENTION

The present invention is directed to providing a thermal runaway-preventing busbar device and a battery system that reduce costs for applying exterior materials, secure thermal runaway prevention performance and maximize space utilization inside the battery system.

The objects of the present invention are not limited to the tasks described above, and other tasks not described will be clearly understood by those skilled in the art from the description below.

According to an aspect of the present invention, there is provided a thermal runaway-preventing busbar device including a first busbar including a first body extending in a longitudinal direction and first connectors which are respectively connected to both ends of the first body, wherein the first busbar is provided as a pair and disposed in parallel, a second busbar including a second body extending parallel to the first body and second connectors, which are bent and extended in directions opposite to the first body at both ends of the second body, wherein the second busbar is provided as a pair and disposed on both sides in a width direction with the first busbar interposed therebetween, a holder insertion-coupled to the first body and the second body so that the first body is spaced a regular interval from the second body, and a frame which is mounted within a separation space provided between battery modules and includes an accommodation groove to accommodate the first busbar and the second busbar therein.

In a state in which the first busbar and the second busbar are fitted and coupled in the holder, the holder may be fastened in the accommodation groove and then fixed in the frame.

In a state in which the first busbar and the second busbar are fixed in the frame, the first body and the second body may be disposed in a structure extending in the longitudinal direction of the accommodation groove in the accommodation groove, the first connectors are disposed in a structure extending outward from both ends of the frame in the longitudinal direction, respectively, and the second connectors are disposed in a structure extending outward from both sides of the frame, respectively.

The first connector may be connected to a connector, which is connected to an external device, and the second connectors may be connected to terminals of the battery modules disposed on both sides of the frame in the width direction.

The holder may be disposed above a bottom surface of the accommodation groove in a state of being fastened to the accommodation groove.

The holder may include a plurality of insertion grooves, the plurality of insertion grooves are spaced apart from each other in a width direction of the accommodation groove, and based on the width direction of the accommodation groove, the first body is inserted into the center, and the second body is inserted and fitted and coupled thereto at the outside.

In the frame, a duct through which air flows may be provided under the receiving groove.

The first body may be formed by overlapping a plurality of thin copper plates, the first connector is formed of a single copper plate, and the first busbar is formed in a structure in which the first connectors are connected to both ends of the first body by welding.

The second body and the second connector may be formed of a single copper plate, and the second busbar may be formed in a structure in which the second body and the second connector are integrally connected by bending the second connector at both ends of the second body.

The first busbar may be provided to have a structure whose length is longer than the second busbar.

A filler provided in the receiving groove may be further included.

A carbon dioxide capsule may be provided in the filler.

According to another aspect of the present invention, there is provided a battery system including a battery case including a storage space, a plurality of battery modules arranged in a form of a grid within the storage space, and a busbar device which is mounted in a separation space provided between the plurality of battery modules and electrically connected to the plurality of battery modules.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram schematically illustrating a battery system according to an embodiment of the present invention;

FIG. 2 is a diagram schematically illustrating a cross-section of the battery system along line I-I of FIG. 1;

FIG. 3 is a perspective view schematically illustrating a thermal runaway-preventing busbar device according to an embodiment of the present invention;

FIG. 4 a front view schematically illustrating the thermal runaway-preventing busbar device of FIG. 3;

FIG. 5 is an exploded perspective view schematically illustrating the thermal runaway-preventing busbar device of FIG. 3;

FIG. 6 is a perspective view schematically illustrating a first busbar and a second busbar of FIG. 5;

FIG. 7A is a front view schematically illustrating a holder of FIG. 5;

FIG. 7B is a plan view schematically illustrating the holder of FIG. 5;

FIG. 8A is a diagram schematically illustrating a cross section of the thermal runaway-preventing busbar device along line II-II of FIGS. 3; and

FIG. 8B is an enlarged diagram of portion “A” of FIG. 8A.

### DETAILED DESCRIPTION OF EXEMPLARY EMBODIMENTS

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Hereinafter, embodiments will be described in detail with reference to the accompanying drawings, but the same or corresponding components regardless of reference numerals are given the same reference numerals, and overlapping descriptions thereof will be omitted.

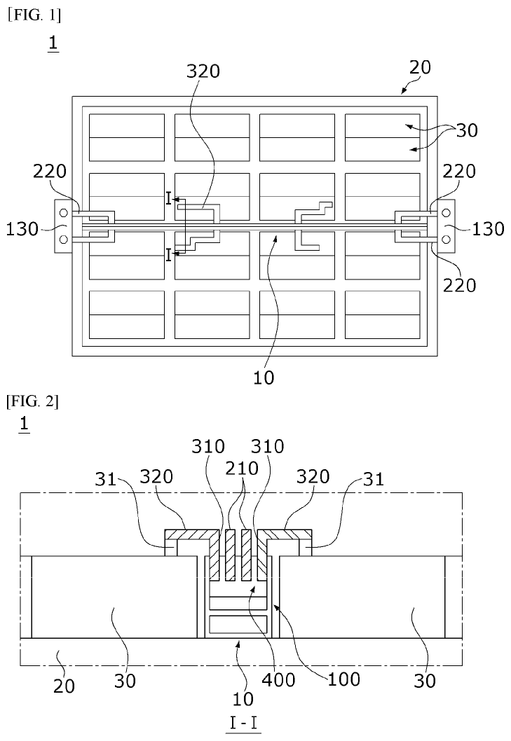

FIG. 1 is a diagram schematically illustrating a battery system according to an embodiment of the present invention, and FIG. 2 is a diagram schematically illustrating a cross-section of the battery system along line I-I of FIG. 1.

Referring to the drawings, a battery system 1 according to the embodiment of the present invention may include a busbar device 10, a battery case 20, and a battery module 30.

The battery case 20 includes a storage space therein and may be formed of a solid material such as a metal.

In the embodiment, the battery case 20 has a structure having an open upper surface and may be formed so that the open upper surface is covered by an upper cover (not shown) to seal the storage space.

A plurality of battery modules 30 are provided, and arranged and stored in the horizontal and vertical directions in the form of a grid within the storage space.

Each battery module 30 may be formed of a plurality of battery cells. In this case, the battery cell may have a pouch-shaped or prismatic structure.

The busbar device 10 may be mounted in a separation space provided between the plurality of battery modules 30. In addition, the busbar device 10 may be electrically connected to the plurality of battery modules 30.

Unlike the conventional battery system in which the busbar device connecting the battery modules 30 is disposed on the battery modules 30 and has a layout of a path on the modules, in the battery system 1 according to a present embodiment, there is a difference in that the busbar device 10 is disposed between the battery modules 30 not on the battery modules 30 and has a layout of a path between modules.

Accordingly, it is possible to prevent a fire from occurring due to thermal runaway according to thermal diffusion when the flame generated in any one conventional battery module 30 transfers heat to another battery module 30 through the busbar device disposed on the battery modules 30. As such, the busbar device 10 according to the present embodiment may implement the thermal runaway prevention function.

Hereinafter, the busbar device 10 according to the present embodiment will be described in more detail with reference to drawings.

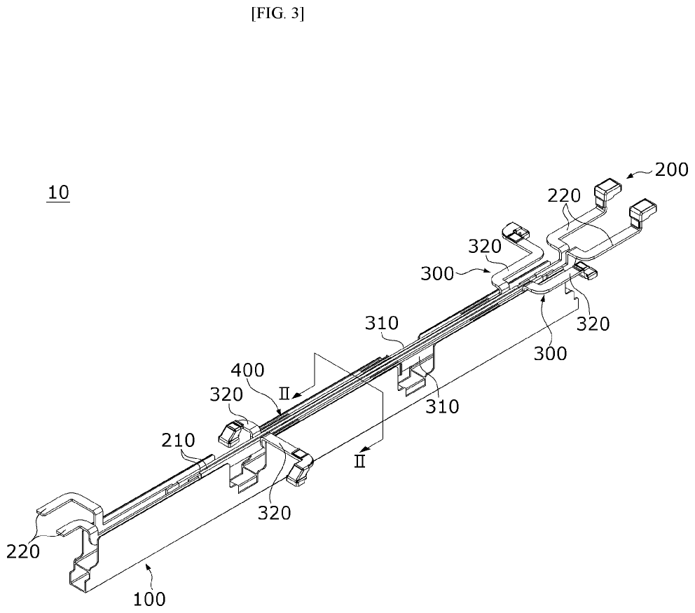

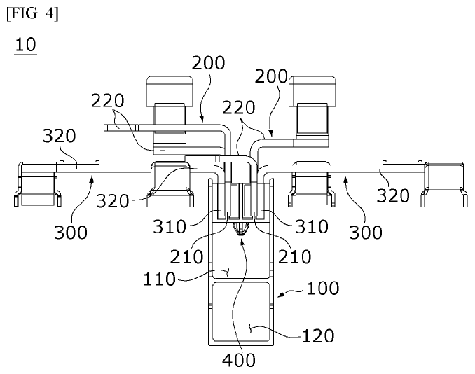

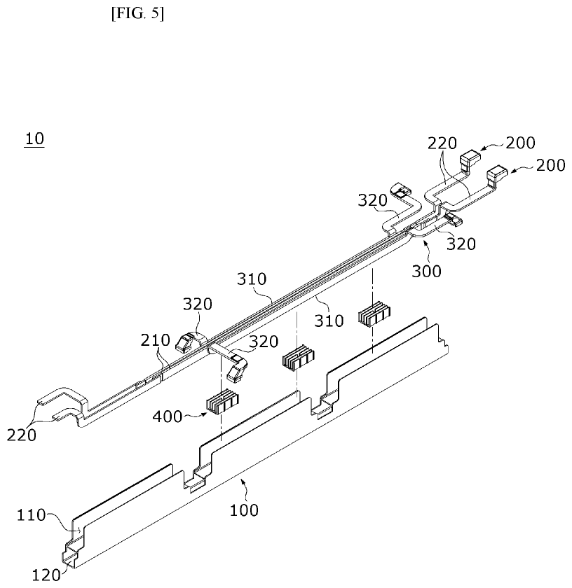

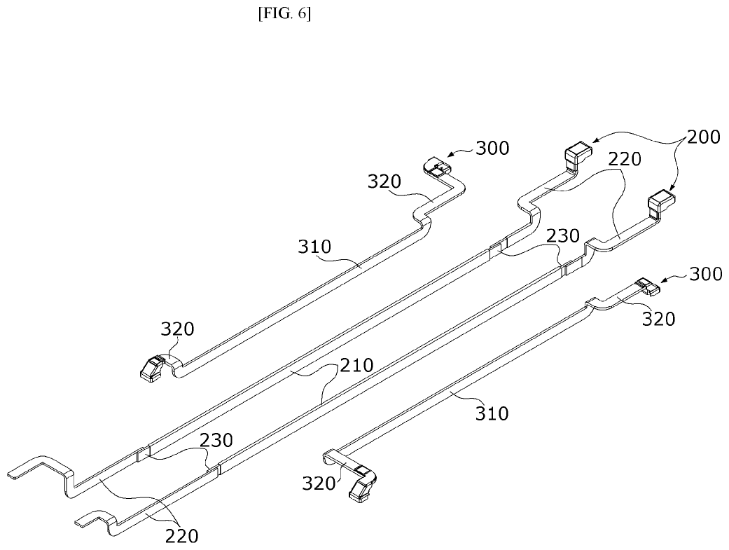

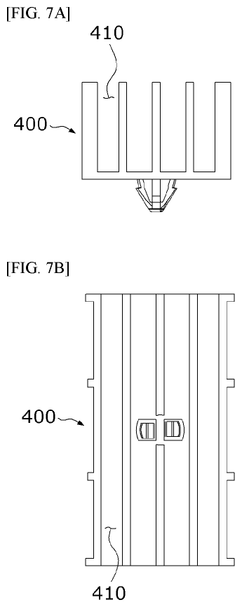

FIG. 3 is a perspective view schematically illustrating a thermal runaway-preventing busbar device according to an embodiment of the present invention, FIG. 4 is a front view schematically illustrating the thermal runaway-preventing busbar device of FIG. 3, and FIG. 5 is an exploded perspective view schematically illustrating the thermal runaway-preventing busbar device of FIG. 3. FIG. 6 is a perspective view schematically illustrating a first busbar and a second busbar of FIG. 5, FIG. 7A is a front view schematically illustrating a holder of FIG. 5, and FIG. 7B is a plan view schematically illustrating the holder of FIG. 5.

Referring to the drawings, the busbar device 10 for preventing the thermal runaway according to the present invention may include a frame 100, first busbars 200, second busbars 300, and holders 400.

The frame 100 has a long rod shape structure extending in a longitudinal direction and may have an accommodation groove 110 having an open upper surface.

The first busbar 200 and the second busbar 300, which will be described below, may be accommodated and fixed in the accommodation groove 110.

In a state in which the first busbar 200 and the second busbar 300 are accommodated in the frame 100, the frame 100 may be mounted in the separation space provided between the battery modules 30. Accordingly, the frame 100 may have a cross section thickness in a width direction corresponding to a gap between the battery modules 30.

In the embodiment, the frame 100 may be formed of an aluminum extruded material. In addition, a duct 120 through which air flows may be provided under the accommodation groove 110 of the frame 100. The duct 120 may be provided in a long structure extending in the longitudinal direction of the frame 100.

Heat generated in the battery module 30 on one side may be discharged to the outside together with air moving through the duct 120 before being transferred to the battery module 30 on the other side.

In the embodiment, a refrigerant, fire extinguishing agent, or the like may be provided in the duct 120 to prevent the spread of thermal runaway in the event of a fire.

The first busbar 200 may include a first body 210 extending in the longitudinal direction and first connectors 220 connected to both ends of the first body 210. In addition, the first busbars 200 may be provided as a pair and disposed in parallel.

In the embodiment, the first body 210 may be formed by overlapping a plurality of thin copper plates. Accordingly, the first body 210 may have a flexible characteristic so that the first body 210 can bend fully in the width direction.

The first connector 220 may be formed of a single copper plate having a much greater thickness than the thin copper plate forming the first body part 210. Accordingly, the first connector 220 may have a rigid characteristic.

The first busbar 200 may be formed in a structure in which the first connectors 220 are connected to both ends of the first body 210 by welding. That is, a welding part 230 interconnecting the first body 210 and the first connector 220 may be provided between the first body 210 and the first connector 220.

As shown in the drawings, in a state in which the first connectors 220 are connected to both ends of the first bodies 210, which are disposed in parallel in the longitudinal direction, and bend and extend in the upward direction of the first body 210, the first connectors 220 may be provided in a structure that variously bends and extends in the width direction, the longitudinal direction, and the upward direction.

The second busbar 300 may include a second body 310, which extends to be parallel to the first body 210, and second connectors 320, which bend and extend in directions opposite to the first body 210 at both ends of the second body 310. In addition, the second busbar 300 may be provided as a pair and the second busbars 300 are disposed on both sides in the width direction with the first bus bar 200 interposed therebetween.

In the embodiment, the second body 310 and the second connector 320 are formed of a single copper plate. Accordingly, the second body 310 and the second connector 320 may have the rigid characteristic.

The second busbar 300 may be formed in a structure in which the second body 310 and the second connector 320 are integrally connected by bending the second connector 320 at both ends of the second body 310.

As shown in the drawings, in a state in which the second connectors 320 are connected to both ends of the second bodies 310, which are disposed in parallel in the longitudinal direction, and bend and extend in the upward direction of the second body 310, the second connectors 320 may be provided in a structure that variously bends and extends in the width direction and the longitudinal direction.

Meanwhile, the first busbar 200 may be provided to have a structure whose length is longer than the second bus bar 300.

A holder 400 may be insertion-coupled to the first body 210 of the first busbar 200 and the second body 310 of the second busbar 300. Accordingly, the holder 400 may support the first body 210 and the second body 310 in a state of being spaced a regular interval from each other.

In the embodiment, the holder 400 may be formed of heat-resistant polypropylene (PP) material. However, the material of the holder 400 is not limited thereto.

As shown in the drawings, the holder 400 may include a plurality of insertion grooves 410. The plurality of insertion grooves 410 may be spaced apart from each other in a width direction of the accommodation groove 110. In addition, based on the width direction of the accommodation groove 110, the first bodies 210 of the first busbars 200 are inserted into the center and the second bodies 310 of the second busbars 300 are insertion-coupled thereto at the outside.

Accordingly, in a state in which the second busbar 300 and the first busbar 200 are insertion-coupled to the holder 400, the holder 400 is fastened in the accommodation groove 110 and then fixed in the frame 100. That is, the first busbar 200 and the second busbar 300 are fixed in the frame 100 through the holder 400.

In this way, in a state in which the first busbar 200 and the second busbar 300 are fixed in the frame 100, the first body 210 and the second body 310 may be disposed in a structure extending in the longitudinal direction of the accommodation groove 110 in the accommodation groove 110.

In addition, the first connectors 220 of the first busbar 200 may be disposed in a structure extending outward from both ends of the frame 100 in the longitudinal direction, and the second connectors 320 of the second busbar 300 may be disposed in a structure extending outward from both sides of the frame 100 in the width direction.

The first connector 220 of the first busbar 200 is connected to the connector 130, which is connected to an external device. The second connectors 320 of the second busbar 300 may be connected to terminals 31 of the battery modules 30, which are disposed on both sides of the frame 100 in the width direction.

In the embodiment, the holder 400 may be disposed above a bottom surface of the accommodation groove 110 in a state of being fastened to the receiving groove 110. That is, in a state in which an outer surface of the holder 400 is insertion-coupled to the inner surface of the receiving groove 110, the holder 400 may be fastened to the frame 100 in a structure spaced apart from the bottom surface of the receiving groove 110.

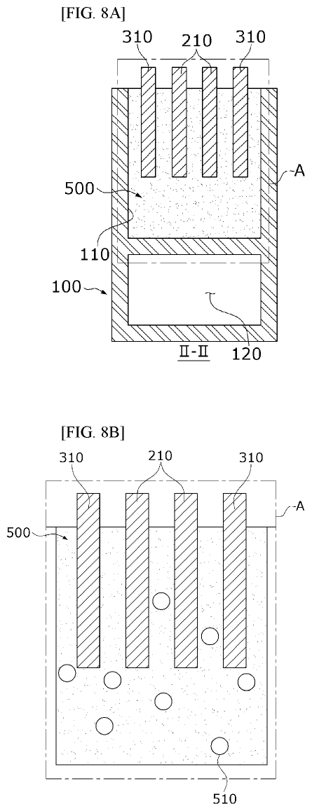

Meanwhile, FIG. 8A is a diagram schematically illustrating a cross section of the thermal runaway-preventing busbar device along line II-II of FIG. 3, and FIG. 8B is an enlarged diagram of portion “A” of FIG. 8A.

As shown in the drawings, a filler 500 may be provided in the accommodation groove 110.

A material with high conductivity may be used as the filler 500, and consequently, an effect of dissipating heat to the outside along the frame 100 can be more improved.

In the embodiment, a material that is a fire extinguishing material or a material that absorbs heat and undergoes a phase change may be used as the filler 500. In this case, it is possible to maintain a temperature lower than or equal to a critical point at which the first busbar 200 and the second busbar 300 can ignite. Accordingly, heat conduction to the battery module 30 can be reduced by the first busbar 200 and the second busbar 300.

Meanwhile, it is possible to provide a carbon dioxide capsule 510 in the filler 500. The carbon dioxide capsule 510 may perform an extinguishing function through spraying non-flammable gas

The filler 500 may be provided in the form of a paint in addition to being provided in a structure for filling the inside of the receiving groove 110. When a weight increase due to the filler 500 becomes a problem, the filler 500 may be configured in the form of the paint to absorb the heat of the first busbar 200 and the second busbar 300.

As described above, the battery system 1 according to the present embodiment includes the busbar device 10 mounted between the battery modules 30, and the first busbar 200 and the second busbar 300 constituting the busbar device 10 are disposed between the battery modules 30 instead of above the battery module 30. Accordingly, in a structure with the conventional layout of the path on the module, a problem in which heat from the flame is conducted to another battery module along the busbar and causes a fire can be prevented.

In particular, by configuring heat to be quickly discharged to the outside through the frame 100 disposed between the battery modules 30, it is possible to prevent heat generated from a fire in the battery module 30 on one side from being transferred to the battery module 30 on the other side through the busbar device 10.

In addition, space utilization can be maximized inside the battery system 1 through a structure in which the busbar device 10 is disposed between the battery modules 30 instead of above the battery module 30, and since the frame 100 replaces the exterior material applied to the conventional busbar, the problem of a cost increase due to the thickness of the exterior material can be solved.

According to the embodiments of the present invention, a thermal runaway-preventing busbar device and battery system, which reduce costs for applying exterior materials, secure thermal runaway prevention performance and maximize space utilization inside the battery system, can be provided.

The effects of the present invention are not limited to the effects described above, and other effects not described will be clearly understood by those skilled in the art from the description of the claims.

It will be apparent to those skilled in the art that various modifications can be made to the above-described exemplary embodiments of the present disclosure without departing from the spirit or scope of the invention. Thus, it is intended that the present disclosure covers all such modifications provided they come within the scope of the appended claims and their equivalents.

What is claimed is:

1. A thermal runaway-preventing busbar device, comprising:
a pair of first busbars disposed in parallel, each first busbar of the pair of first busbars including a first body extending in a longitudinal direction and first connectors connected to both ends of the first body;
a pair of second busbars disposed on both sides in a width direction with the pair of first busbars interposed therebetween, each second busbar of the pair of second busbars including a second body extending parallel to the first body and second connectors, which bend and extend in directions opposite to the first body at both ends of the second body;
a holder insertion-coupled to the first body and the second body so that the first body is spaced a regular interval from the second body; and
a frame mounted within a separation space provided between battery modules and including an accommodation groove having an open upper surface to accommodate the pair of first busbars and the pair of second busbars therein.

2. The device of claim 1, wherein, in a state in which the pair of first busbars and the pair of second busbars are insertion-coupled to the holder, the holder is fastened in the accommodation groove and then fixed in the frame.

3. The device of claim 1 or 2, wherein, in a state in which the pair of first busbars and the pair of second busbars are fixed in the frame, the first body and the second body are disposed in a structure extending in a longitudinal direction of the accommodation groove in the accommodation groove, the first connectors are disposed in a structure extending outward from both ends of the frame in a longitudinal direction, and the second connectors are disposed in a structure extending outward from both sides of the frame in a width direction.

4. The device of claim 3, wherein the first connector is connected to a connector, which is connected to an external device, and the second connectors are connected to terminals of the battery modules disposed on both sides of the frame in the width direction.

5. The device of claim 2, wherein the holder is disposed above a bottom surface of the accommodation groove in a state of being fastened to the accommodation groove.

6. The device of claim 1, wherein the holder includes a plurality of insertion grooves, the plurality of insertion grooves are spaced apart from each other in a width direction of the accommodation groove, and based on the width direction of the accommodation groove, the first body is inserted into the center, and the second body is insertion-coupled thereto at the outside.

7. The device of claim 1, wherein, in the frame, a duct through which air flows is provided under the accommodation groove.

8. The device of claim 1, wherein the first body is formed by overlapping a plurality of thin copper plates, the first connector is formed of a single copper plate, and each first busbar of the pair of first busbars is formed in a structure in which the first connectors are connected to both ends of the first body by welding.

9. The device of claim 1, wherein the second body and the second connector are formed of a single copper plate, each second busbar of the pair of second busbar is formed in a structure in which the second body and the second connector are integrally connected by bending the second connector at both ends of the second body.

10. The device of claim 1, wherein the pair of first busbars has a longer length than the pair of second busbars.

11. The device of claim 1, further comprising a filler provided in the accommodation groove.

12. The device of claim 11, wherein a carbon dioxide capsule is provided in the filler.

13. A battery system comprising:
a battery case including a storage space;
a plurality of battery modules arranged in a form of a grid within the storage space; and
a busbar device mounted in a separation space provided between the plurality of battery modules and electrically connecting the plurality of battery modules,
wherein the busbar device includes:
a pair of first busbars disposed in parallel, each first busbar of the pair of first busbars including a first body extending in a longitudinal direction and first connectors connected to both ends of the first body;
a pair of second busbars disposed on both sides in a width direction with the pair of first busbars interposed therebetween, each second busbar of the pair of second busbars including a second body extending parallel to the first body and second connectors, which bend and extend in directions opposite to the first body at both ends of the second body;
a holder insertion-coupled to the first body and the second body so that the first body is spaced a regular interval from the second body; and
a frame mounted within a separation space provided between battery modules and including an accommodation groove having an open upper surface to accommodate the pair of first busbars and the pair of second busbars therein.

14. The battery system of claim 13, wherein, in a state in which the pair of first busbars and the pair of second busbars are insertion-coupled to the holder, the holder is fastened in the accommodation groove and then fixed in the frame.

15. The battery system of claim 13, wherein, in a state in which the pair of first busbars and the pair of second busbars are fixed in the frame, the first body and the second body are disposed in a structure extending in a longitudinal direction of the accommodation groove in the accommodation groove, the first connectors are disposed in a structure extending outward from both ends of the frame in a longitudinal direction, and the second connectors are disposed in a structure extending outward from both sides of the frame in a width direction.

16. The battery system of claim 15, wherein the first connector is connected to a connector, which is connected to an external device, and the second connectors are connected to terminals of the battery modules disposed on both sides of the frame in the width direction.

17. The battery system of claim 14, wherein the holder is disposed above a bottom surface of the accommodation groove in a state of being fastened to the accommodation groove.

18. The battery system of claim 13, wherein the holder includes a plurality of insertion grooves, the plurality of insertion grooves are spaced apart from each other in a width direction of the accommodation groove, and based on the width direction of the accommodation groove, the first body is inserted into the center, and the second body is insertion-coupled thereto at the outside.

19. The battery system of claim 13, wherein, in the frame, a duct through which air flows is provided under the accommodation groove.

20. The battery system of claim 13, wherein the first body is formed by overlapping a plurality of thin copper plates, the first connector is formed of a single copper plate, and each first busbar of the pair of first busbars is formed in a structure in which the first connectors are connected to both ends of the first body by welding.
